(19) United States
(12) Patent Application Publication
(10) Pub. No.: US 2017/0207697 A1
(43) Pub. Date: Jul. 20, 2017

(54) WEIGHTED VOLTAGE-CAPACITOR CLUSTERS WITH CLOUD-CHARGING FOR ULTRA-FAST VOLTAGE SCALING WITH NO CHARGE REDISTRIBUTION LOSS

(71) Applicant: Washington State University, Pullman, WA (US)

(72) Inventors: Deuk Hyoun Heo, Pullman, WA (US); Zhiyuan Zhou, Pullman, WA (US); Nghia Tang, Dallas, TX (US)

(21) Appl. No.: 15/406,051

(22) Filed: Jan. 13, 2017

Related U.S. Application Data
(60) Provisional application No. 62/279,200, filed on Jan. 15, 2016.

(51) Int. Cl. H02M 3/06; G06F 1/32

(52) U.S. Cl. CPC H02M 3/06; G06F 1/3296

(57) ABSTRACT

An on-chip power management system includes one or more processing cores and one or more switched capacitor voltage regulators, each supplying power at an output voltage to one of the cores. One or more flying capacitors supply the power at a supply voltage to each of the switched capacitor voltage regulators. A flying capacitor controller allocates each of the flying capacitors to the switched capacitor voltage regulators.

### CROSS-REFERENCE TO RELATED APPLICATIONS

This application claims benefit under 35 U.S.C. 119 to U.S. application Ser. No. 62/279,200, filed on Jan. 13, 2016, which is incorporated herein by reference in its entirety.

### BACKGROUND

In modern high-performance multi-core chips, power consumption and heat dissipation have become dominant constraints due to factors such as cost, performance, reliability, scalability, and environmental impact. Increased power consumption can raise the operating temperature of the chip, which in turn can compromise reliability and achievable performance, and increase the cooling costs.

The two principal power management strategies in multi-core chips are Dynamic Voltage and Frequency Scaling (DVFS) and Voltage Frequency Island (VFI). In DVFS, the voltage and frequency of each core and network element are fine-tuned individually, depending on the workload and traffic patterns of the cores. In VFI, a group of cores and their associated network elements are clustered according to their computation and communications patterns. Then each cluster is assigned a single voltage and frequency level. VFI can reduce the heat generated by multi-core chips by taking advantage of the varying nature of execution workloads. The voltage and frequency (VF) levels of the VFIs can be tailored dynamically to workload variations. Use of dynamically tuned VFIs may have less complexity than use of fully distributed per core DVFS.

VFI chip designs are thus promising due to their ability to reduce overall energy dissipation in multi-core chips. By tailoring the voltages and frequencies of each VFI domain, they can achieve significant energy savings subject to specific performance constraints. However, the effectiveness of a VFI-based system cannot be fully exploited without efficient and scalable on-chip power management system (PMS) and VF control mechanisms. Hence, there is an ongoing need for a highly efficient PMS scheme.

Conventional switching regulators typically do not operate efficiently with on-chip PMS. The main reason is that switching regulators require inductors and/or capacitors, which are inefficient in terms of power and area consumption on integrated circuits. Various solutions have been disclosed to improve the performance of inductor-based switching regulators, which achieve efficiency in the vicinity of 70%-80%, but on-chip inductors are still very large, resulting in low power density (i.e., maximum power per unit area). One regulator is typically needed for each core, making it challenging to efficiently use inductor-based switching regulators in multi-core systems.

A potential solution is to use single-inductor-multiple-output (SIMO) regulators. One conventional solution utilizes an off-chip inductor to improve efficiency, but only manages to provide milliwatt-level power. The amount of power and the number of cores each SIMO regulator can support is limited. For multi-core systems with watt-level power demand, multiple SIMO regulators with bulky inductors are required, a costly solution.

Reconfigurable switched capacitor voltage regulators (SCVRs) have been demonstrated as an on-chip PMS solution for multi-core systems, with the following advantages: 1) they demonstrate high power efficiency over a wide voltage range due to reconfigurable topologies; 2) they have high power density due to high-density capacitor technologies; and 3) they are highly scalable because capacitors may be efficiently added and distributed throughout the chip. Some such designs have reported efficiency above 80% and power density on the order of W/mm² or A/mm² by utilizing reconfigurable topologies and deep-trench capacitors. Most have focused on improving the SCVRs by improving the reconfigurable topologies with a wider range of output voltages and fewer capacitors.

However, without considering the global dynamic behavior of all the cores, an on-chip PMS with individually optimized SCVRs will deliver sub-optimal performance. By considering the dynamic behavior of the cores and their interactions, it is possible to improve the performance of both the PMS and the multi-core systems it supplies. Voltage-stacking mechanism enable the entire PMS (i.e., not individual SCVRs) to be reconfigured. Voltage-stacking may improve power efficiency and alleviate the burden on the individual SCVRs, but it is highly susceptible to voltage imbalance among the cores and poor voltage regulation.

The main drawback of the current solutions in SCVR-based PMS is that none of the existing work account for the voltage scaling time and power loss involved with voltage scaling. Energy saving techniques for multi-core systems, e.g., dynamic VFI, requires the cores' supply voltage to scale up and down quickly in less than 100 ns, but very few SCVRs can efficiently achieve such fast voltage scaling time. In conventional reconfigurable SCVRs, voltage scaling requires charging and discharging the flying capacitors to a new voltage, which leads to charge redistribution loss and delay.

In existing on-chip SCVR-based PMSs for multi-core processors, each core has its own SCVR to control the supply voltage, and the SCVRs operate independently from one another. Each SCVR is customized with constant values of flying capacitors and output capacitors. Ideally, it is desirable to have capacitors that are as large as possible for high efficiency, high output power, and low output voltage ripple. However, the total capacitor size is always limited by the constraint of chip area, thus limiting the performance of the SCVR. If power demands of the cores vary with time, a conventional PMS has a severe drawback. When a core demands low power, the capacitor resource, especially flying capacitors of the associated SCVR, is underutilized. Meanwhile, in another core with higher power demand, the associated SCVR can benefit from having larger capacitors, but it only has access to its limited allocation of capacitors.

### SUMMARY

Disclosed herein are embodiments of fully-integrated dynamic capacitor and weighted-voltage power management systems. Innovations in circuit design are utilized to design energy efficient multi-core chips.

The disclosed embodiments utilize dynamic allocation of a “cloud capacitor” PMS to improve the efficiency of the power distribution network in multi-core systems. A weighted voltage capacitor clusters technique is disclosed to efficiently generate multiple output voltages and enable ultrafast voltage scaling time. The disclosed PMS systems may utilize More-than-Two-Phases (MTTP) SCVR topologies to maximize performance of the cloud-capacitor PMS. Mathematical models of the cloud capacitor PMS and the MTTP SCVRs are generated to facilitate design and optimization of on-chip PMSs.

This innovation addresses power-thermal-performance trade-offs of sustainable multi-core architecture in a highly integrated fashion by adopting a vertical design flow by addressing the design of efficient circuits to enable VFI-based power management.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a conventional on-chip PMS allocation 100 of flying capacitors in a multi-core integrated circuit.

FIG. 2 illustrates an on-chip PMS allocation 200 with dynamic capacitor allocation of flying capacitors in a multi-core integrated circuit.

FIG. 3 illustrates a DCA model 300 for an exemplary 36-core on-chip power management system in accordance with one embodiment.

FIG. 4 illustrates a flying capacitor grouping 400 in accordance with one embodiment.

FIG. 5 illustrates voltage scaling 500 for a VFI arrangement in accordance with one embodiment.

FIG. 6 illustrates voltage scaling 600 for a VFI arrangement in accordance with another embodiment.

FIG. 7 illustrates a cloud charging process 700 for flying capacitors in accordance with one embodiment.

FIG. 8 illustrates a first waveform 800 of a three-phase SCVR, which regulates voltages of three VFIs and two WVC clusters, in accordance with one embodiment.

FIG. 9 illustrates a second waveform 900 of a three-phase SCVR, which regulates voltages of three VFIs and two WVC clusters, in accordance with one embodiment.

FIG. 10 illustrates a voltage waveform 1000 of a three-phase SCVR, which regulates voltages of three VFIs and two WVC clusters, in accordance with one embodiment.

FIG. 11 illustrates an embodiment of an on-chip power management system 1100.

FIG. 12 illustrates an embodiment of a flying capacitor allocation method 1200.

FIG. 13 illustrates an embodiment of a subroutine block 1300.

FIG. 14 illustrates an embodiment of a subroutine block 1400.

### DETAILED DESCRIPTION

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic operations described herein may be implemented in logic that is referred to using a noun or noun phrase reflecting said operation. For example, an association operation may be carried out by an “associator” or “correlator”. Likewise, switching may be carried out by a “switch”, selection by a “selector”, and so on.

“Associator” in this context refers to a correlator (see the definition for Correlator).

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Classifier” in this context refers to a specific type of correlator/associator logic that associates one or more inputs with a category, class, or other group sharing one or more common characteristics. An example of a classifier that may commonly be implemented in programmable hardware is a packet classifier used in network switches, firewalls, and routers (e.g., packet classifiers utilizing Ternary Content Addressable Memories). An example software or firmware classifier is: if (input1.value<12.5) input1.group=group1; else if (input1.value>=12.5 and input1.value<98.1) input1.group=group2; else input1.group=group3; other examples of classifiers will be readily apparent to those of skill in the art, without undo experimentation.

“Combiner” in this context refers to a logic element that combines two or more inputs into fewer (often a single) output. Example hardware combiners are arithmetic units (adders, multipliers, etc.), time-division multiplexers, and analog or digital modulators (these may also be implemented is software or firmware). Another type of combiner builds an association table or structure (e.g., a data structure instance having members set to the input values) in memory for its inputs. For example: val1, val2, val3->combiner logic->{val1, val2, val3} set.val1=val1; set.val2=val2; set.val3=val3; other examples of combiners will be evident to those of skill in the art without undo experimentation.

“Comparator” in this context refers to a logic element that compares two or more inputs to produce one or more outputs that reflects similarity or difference of the inputs. An example of a hardware comparator is an operational amplifier that outputs a signal indicating whether one input is greater, less than, or about equal to the other. An example software or firmware comparator is: if (input1==input2) output=val1; else if (input1>input2) output=val2; else output=val3; Many other examples of comparators will be evident to those of skill in the art, without undo experimentation.

“Correlator” in this context refers to a logic element that identifies a configured association between its inputs. One examples of a correlator is a lookup table (LUT) configured in software or firmware. Correlators may be implemented as relational databases. An example LUT correlator is: |low_alarm_condition|low_threshold_value|0|safe_condition|safe_lower_bound|safe_upper_bound∥high_alarm_condition|high_threshold_value|0|. Generally, a correlator receives two or more inputs and produces an output indicative of a mutual relationship or connection between the inputs. Examples of correlators that do not use LUTs include any of a broad class of statistical correlators that identify dependence between input variables, often the extent to which two input variables have a linear relationship with each other. One commonly used statistical correlator is one that computes Pearson's product-moment coefficient for two input variables (e.g., two digital or analog input signals). Other well-known correlators compute a distance correlation, Spearman's rank correlation, a randomized dependence correlation, and Kendall's rank correlation. Many other examples of correlators will be evident to those of skill in the art, without undo experimentation.

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Selector” in this context refers to a logic element that selects one of two or more inputs to its output as determined by one or more selection controls. Examples of hardware selectors are multiplexers and demultiplexers. An example software or firmware selector is: if (selection_control==true) output=input1; else output=input2; Many other examples of selectors will be evident to those of skill in the art, without undo experimentation.

“Software” in this context refers to logic implemented as processor-executable instructions in a machine memory (e.g. read/write volatile or nonvolatile memory or media).

“Switch” in this context refers to logic to select one or more inputs to one or more outputs under control of one or more selection signals. Examples of hardware switches are mechanical electrical switches for switching power to circuits, devices (e.g., lighting), or motors. Other examples of hardware switches are solid-state switches such as transistors. An example of a hardware or firmware switch is: if (selection==true) output=input; else output=0; A somewhat more complicated software/firmware switch is: if (selection1==true and selection2==true) output=input1; else if (selection1==true and selection2==false) output=input2; else if (selection1==false and selection2==true) output=input3; else output=noOp; Switches operate similarly to selectors in many ways (see the definition of Selector), except in some cases switches may select all inputs to the output, (s) not select among inputs. Other examples of switches will be readily apparent to those having skill in the art, without undo experimentation.

The disclosed system and processes improve energy efficiency in multi-core chips by utilizing an innovative on-chip PMS. Other applications include PMS for energy harvesting, biomedical devices, and mobile devices utilized in the Internet-of-Things (IoT).

To address limitations of conventional systems, an innovative cloud-capacitor PMS with Dynamic Capacitor Allocation (DCA) is disclosed, which may be used for power distribution in massive-multi-core systems. Individual cores retain their own SCVRs to regulate the supply voltages, and the output capacitors are also bound to individual SCVRs.

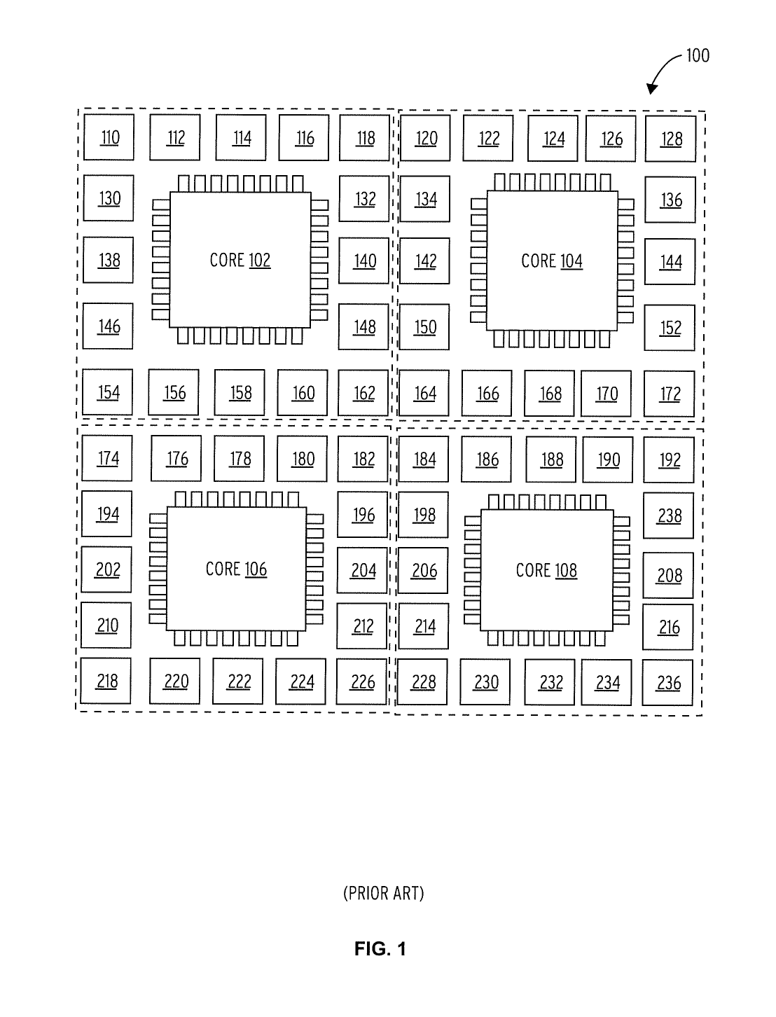

FIG. 1 illustrates a conventional PMS allocation 100 for multiple cores 102-108 and a set of flying capacitors 110-238. The flying capacitors are allocated evenly regardless of power demand on each core. For example:

a. the core 102 may be allocated the flying capacitor 110, the flying capacitor 112, the flying capacitor 114, the flying capacitor 116, the flying capacitor 118, the flying capacitor 130, the flying capacitor 132, the flying capacitor 138, the flying capacitor 140, the flying capacitor 146, the flying capacitor 148, the flying capacitor 154, the flying capacitor 156, the flying capacitor 158, the flying capacitor 160, and the flying capacitor 162;

b. the core 104 may be allocated the flying capacitor 120, the flying capacitor 122, the flying capacitor 124, the flying capacitor 126, the flying capacitor 128, the flying capacitor 134, the flying capacitor 136, the flying capacitor 142, the flying capacitor 144, the flying capacitor 150, the flying capacitor 152, the flying capacitor 164, the flying capacitor 166, the flying capacitor 168, the flying capacitor 170, and the flying capacitor 172.

c. the core 106 may be allocated the flying capacitor 174, the flying capacitor 176, the flying capacitor 178, the flying capacitor 180, the flying capacitor 182, the flying capacitor 194, the flying capacitor 196, the flying capacitor 202, the flying capacitor 204, the flying capacitor 210, the flying capacitor 212, the flying capacitor 218, the flying capacitor 220, the flying capacitor 222, the flying capacitor 224, and the flying capacitor 226; and

d. the core 108 may be allocated the flying capacitor 184, the flying capacitor 186, the flying capacitor 188, the flying capacitor 190, the flying capacitor 192, the flying capacitor 198, the flying capacitor 206, the flying capacitor 208, the flying capacitor 214, the flying capacitor 216, the flying capacitor 228, the flying capacitor 230, the flying capacitor 232, the flying capacitor 234, the flying capacitor 236, and the flying capacitor 238.

The output capacitors of each one or more switched capacitor voltage regulators are evenly distributed, surrounding each core to reduce conduction loss and voltage drop when power is delivered to various parts of the core.

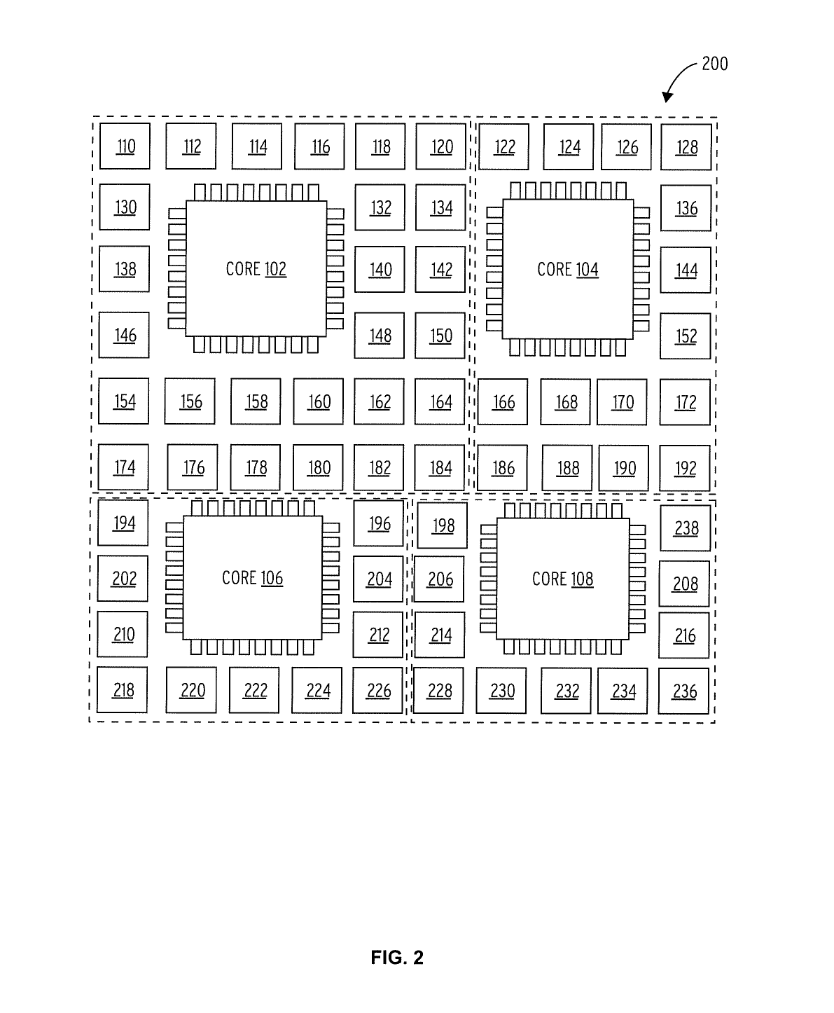

Referring now to FIG. 2, an improved PMS allocation 200 is illustrated for cores 102-108 and flying capacitors 110-238. The flying capacitors are dynamically allocated based on demand on each core.

For example, the demand on the core 102 may be the highest, the demand on the core 104 may be the next highest, and the demand on the core 106 and the core 108 may be similar and the lowest. The core 102 is allocated the flying capacitor 110, the flying capacitor 112, the flying capacitor 114, the flying capacitor 116, the flying capacitor 118, the flying capacitor 120, the flying capacitor 130, the flying capacitor 132, the flying capacitor 134, the flying capacitor 138, the flying capacitor 140, the flying capacitor 142, the flying capacitor 146, the flying capacitor 148, the flying capacitor 150, the flying capacitor 154, the flying capacitor 156, flying capacitor 158, the flying capacitor 160, the flying capacitor 162, the flying capacitor 164, the flying capacitor 174, the flying capacitor 176, the flying capacitor 178, the flying capacitor 180, the flying capacitor 182, and the flying capacitor 184. The number of allocated flying capacitors has increased from 16 to 27 based on the power demand of the core 102 relative to the other cores.

The core 104 is allocated the flying capacitor 122, the flying capacitor 124, the flying capacitor 126, the flying capacitor 128, the flying capacitor 136, the flying capacitor 144, the flying capacitor 152, the flying capacitor 166, the flying capacitor 168, the flying capacitor 170, the flying capacitor 172, the flying capacitor 186, the flying capacitor 188, the flying capacitor 190, and the flying capacitor 192. The number of allocated flying capacitors has decreased from 16 to 15 based on the power demand of the core 104 relative to the other cores.

The core 106 is allocated the flying capacitor 194, the flying capacitor 196, the flying capacitor 202, the flying capacitor 204, the flying capacitor 210, flying capacitor 212, flying capacitor 218, flying capacitor 220, flying capacitor 222, flying capacitor 224, and the flying capacitor 226. The number of allocated flying capacitors has decreased from 16 to 11 based on the power demand of the core 106 relative to the other cores.

The core 108 is allocated the flying capacitor 198, the flying capacitor 238, the flying capacitor 206, the flying capacitor 208, the flying capacitor 214, the flying capacitor 216, the flying capacitor 228, the flying capacitor 230, the flying capacitor 232, flying capacitor 234, and the flying capacitor 236. The number of allocated flying capacitors has decreased from 16 to 11 based on the power demand of the core 108 relative to the other cores.

The output capacitors of each one or more switched capacitor voltage regulators are evenly distributed, surrounding each core to reduce conduction loss and voltage drop when power is delivered to various parts of the core. The flying capacitors, C_{fly}, are shared globally “in the cloud,” and a flying capacitor controller dynamically allocates each C_{fly} to individual one or more switched capacitor voltage regulators depending on the power demands of the cores.

When a core demands lower power, the associated one or more switched capacitor voltage regulators capacitor allocation is decreased such that more of the C_{fly} can be allocated to the one or more switched capacitor voltage regulators of cores with higher power demands. The value of C_{fly} allocated to each one or more switched capacitor voltage regulators is a function of the relative power demands of all cores. As described, the core 102 has higher power demand than the core 104, the core 106, and the core 108 and is assigned with more flying capacitors.

Because the output power of a one or more switched capacitor voltage regulators is proportional to the product of switching frequency f_{sw} and C_{fly}, increasing C_{fly} helps maintain both f_{sw} and switching loss low for a set amount of output power. By allocating the proper value of flying capacitors, the dynamic capacitor allocation reduces total power consumption of a massive multi-core on-chip power management system.

The allocation of C_{fly} determines the performance of the dynamic capacitor allocation. Thus, a mathematical model is disclosed to apply to the analysis and decision on the allocation of C_{fly} among multiple cores with varying power demands. For N number of cores in a multi-core on-chip power management system, the total power consumption Pₜₒₜₐₗ can be estimated as:

$${P}_{total} = {\sum }_{k = 1}^{N} \frac{{P}_{core , k}}{Eff ( {P}_{core , k} , {C}_{fly , k} )} = {\sum }_{k = 1}^{N} \frac{{α}_{k} {P}_{core , max}}{Eff ( {α}_{k} , {C}_{fly , k} )} \qquad Equation 1$$

A core's power demand P_{core,k} can be written as a percentage of the maximum power demand per core P_{core,max}, i.e., P_{core,k}=αₖ P_{core,max} where αₖ (from 0 to 1) is a normalized power ratio of core k. The term Eff(P_{core,k}, C_{fly,k}), or equivalently Eff(αₖ, C_{fly,k}), is the efficiency function of a one or more switched capacitor voltage regulators, which uses C_{fly,k} to provide power for core k. The value of C_{fly} allocated to core k will be determined by a capacitor allocation function C_{fly}(P_{core,i}) where P_{core,i} indicates the power demands of individual cores. The mathematical model provides an improved or optimal capacitor allocation function to reduce or minimize Pₜₒₜₐₗ in Equation 1, for given efficiency characteristics of one or more switched capacitor voltage regulators and the dynamic power demands of multiple cores.

The total power consumption of a 36-core on-chip power management system with and without dynamic capacitor allocation may be modeled. The efficiency of one or more switched capacitor voltage regulators may be modeled by a simple efficiency function, expressed as:

$$Eff ( α , {C}_{fly} ) = \frac{{C}_{fly}}{βα + {C}_{fly}} \qquad Equation 2$$

where β is a topology-dependent parameter. The simple efficiency function represents a typical, roughly accurate efficiency characteristic of one or more switched capacitor voltage regulators. The allocation of C_{fly} follows a simple capacitor allocation function, which is:

C_{fly,k}=αₖCₘₐₓ/Σᵢ₌₁^{N}αᵢ Equation 3

where Cₘₐₓ is the total number of flying capacitors available in the cloud for the whole chip.

The models provided by Equations 1-3 do not include the effects of all relevant factors, such as interconnection, conduction loss, number of voltage levels, number of cores and VFIs, and so on. Additionally, the capacitor allocation function (Equation 3) is of first order, and thus not complete accurate.

A more comprehensive capacitor allocation function includes additional factors such as efficiency of a specific SCVR topology, number of cores, power characteristics of cores, output voltage levels, and complexity of interconnection. A more accurate or optimal capacitor allocation function (e.g., one programmed into the logic of the PMS controller) will achieve greater efficiency for the cloud capacitor PMS in a massive multi-core system. Upon receiving information about the power demands of all cores, the controller computes the capacitor allocation of each core and activates reconfiguration of the system. The control techniques disclosed herein may limit the time for said computation and reconfiguration to within 20 nanoseconds.

SCVRs employed in PMSs for multi-core processors must generate various output voltage levels with fast scaling time. Modulation of switching frequency of an SCVR can change the output voltage, but this results in larger output voltage ripple and lower efficiency. A more efficient method is to reconfigure an SCVR to obtain new voltage conversion ratios. When an SCVR topology is reconfigured, its flying capacitors are charged (or discharged) to a new voltage. For example, in the SCVR described in [D11], if the conversion ratio is changed from ½ of the supply voltage VDD to ⅓ VDD, the flying capacitors are discharged from ½ VDD to ⅓ VDD. The charge/discharge of flying capacitors during reconfiguration leads to significant charge redistribution loss and long voltage scaling time.

The disclosed systems produce desired output voltages at VFIs, while reducing WVC charge redistribution loss and voltage scaling time.

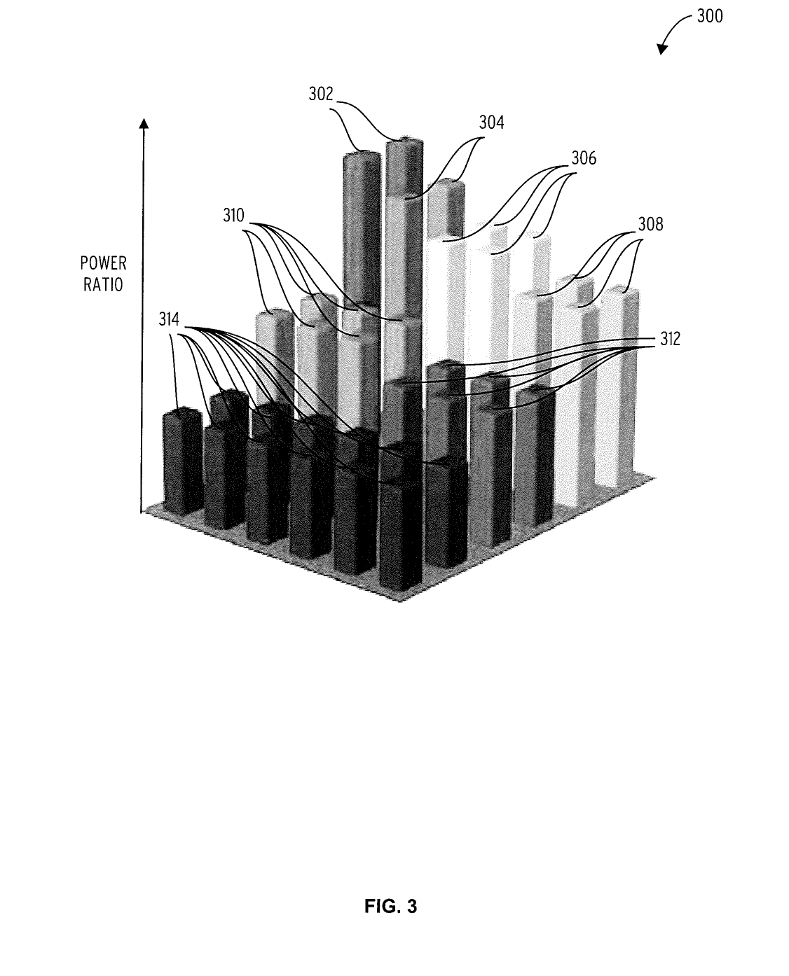

Referring to FIG. 3, the DCA model 300 comprises a voltage frequency island 302, a voltage frequency island 304, a voltage frequency island 306, a voltage frequency island 308, a voltage frequency island 310, a voltage frequency island 312, and a voltage frequency island 314.

Each column in FIG. 3 represents a core, and cores in the same voltage frequency island are assigned the same power demands. With DCA, the C_{fly} allocation to each core depends on the relative power demands of all cores. The DCA model 300 results in 8% reduction of total power consumption of the 36-core on-chip power management system.

TABLE 1

| | | Power | C_{fly}/Cₘₐₓ | C_{fly}/Cₘₐₓ |
|---|---|---|---|---|
| VFI | # Cores | Ratio α | (no DCA) | (with DCA) |
| 1 | 2 | 1 | 0.028 × 2 | 0.047 × 2 |
| 2 | 2 | 0.9 | 0.028 × 2 | 0.042 × 2 |
| 3 | 4 | 0.8 | 0.028 × 4 | 0.038 × 4 |
| 4 | 4 | 0.7 | 0.028 × 4 | 0.033 × 4 |
| 5 | 6 | 0.6 | 0.028 × 6 | 0.028 × 6 |
| 6 | 6 | 0.5 | 0.028 × 6 | 0.024 × 6 |
| 7 | 12 | 0.4 | 0.028 × 12 | 0.019 × 12 |

Table 1 show the results of the DCA model 300. For each voltage frequency island, the number of cores, the power ratio α (described with respect to Equation 1, above), and the ratio of the flying capacitors allocated to each core within the voltage frequency island to the maximum number of flying capacitors for both a conventional allocation and a dynamic capacitor allocation.

As each voltage frequency island has different power demands, as illustrated by the power ratio in Table 1, the flying capacitors are allocated accordingly. The voltage frequency island 302 (listed as VFI 1 in Table 1) has two cores, a power ratio of 1.0, has a C_{fly}/Cₘₐₓ ratio of 0.028 for each core in a conventional allocation scheme, and has a C_{fly}/Cₘₐₓ ratio of 0.047 for each core in a DCA scheme. The voltage frequency island 304 (listed as VFI 2 in Table 1) has two cores, a power ratio of 0.9, has a C_{fly}/Cₘₐₓ ratio of 0.028 for each core in a conventional allocation scheme, and has a C_{fly}/Cₘₐₓ ratio of 0.042 for each core in a DCA scheme. The voltage frequency island 306 (listed as VFI 3 in Table 1) has four cores, a power ratio of 0.8, has a C_{fly}/Cₘₐₓ ratio of 0.028 for each core in a conventional allocation scheme, and has a C_{fly}/Cₘₐₓ ratio of 0.038 for each core in a DCA scheme. The voltage frequency island 308 (listed as VFI 4 in Table 1) has four cores, a power ratio of 0.7, has a C_{fly}/Cₘₐₓ ratio of 0.028 for each core in a conventional allocation scheme, and has a C_{fly}/Cₘₐₓ ratio of 0.033 for each core in a DCA scheme. The voltage frequency island 310 (listed as VFI 5 in Table 1) has six cores, a power ratio of 0.6, has a C_{fly}/Cₘₐₓ ratio of 0.028 for each core in a conventional allocation scheme, and has a C_{fly}/Cₘₐₓ ratio of 0.028 for each core in a DCA scheme. The voltage frequency island 312 (listed as VFI 6 in Table 1) has six cores, a power ratio of 0.5, has a C_{fly}/Cₘₐₓ ratio of 0.028 for each core in a conventional allocation scheme, and has a C_{fly}/Cₘₐₓ ratio of 0.024 for each core in a DCA scheme. The voltage frequency island 312 (listed as VFI 7 in Table 1) has 12 cores, a power ratio of 0.4, has a C_{fly}/Cₘₐₓ ratio of 0.028 for each core in a conventional allocation scheme, and has a C_{fly}/Cₘₐₓ ratio of 0.019 for each core in a DCA scheme.

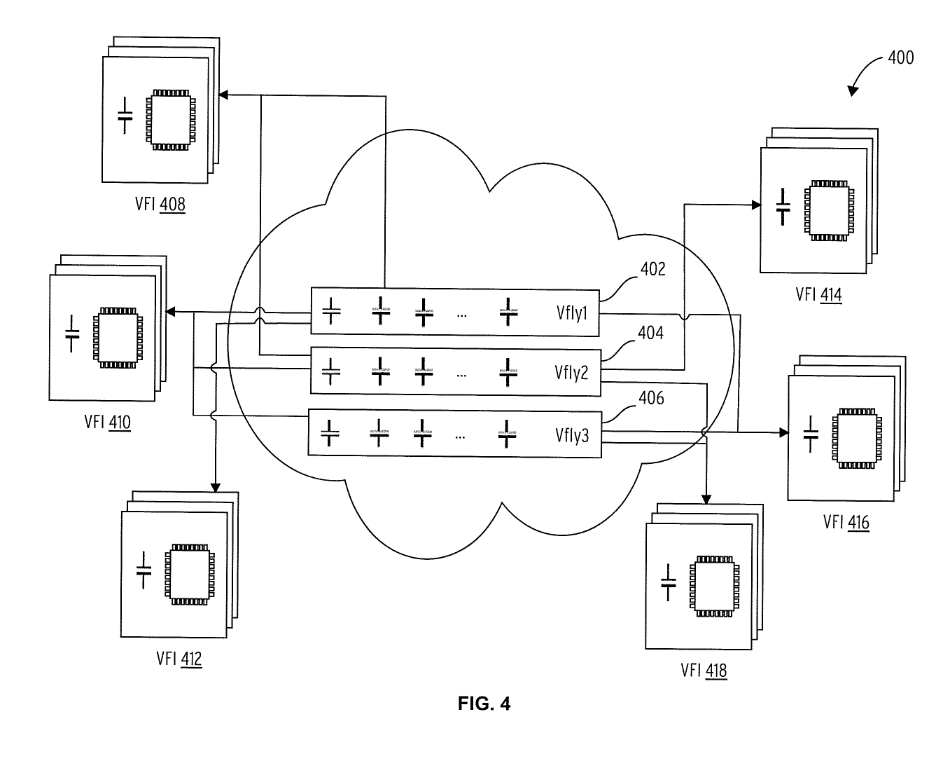

Referring to FIG. 4, the flying capacitor grouping 400 comprises a weighted voltage capacitor cluster 402, a weighted voltage capacitor cluster 404, a weighted voltage capacitor cluster 406, a voltage frequency island 408, a voltage frequency island 410, a voltage frequency island 412, a voltage frequency island 414, a voltage frequency island 416, and a voltage frequency island 418.

Flying capacitors may be in the cloud and are grouped into Weighted-Voltage-Capacitor (WVC) clusters (the weighted voltage capacitor cluster 402, the weighted voltage capacitor cluster 404, and the weighted voltage capacitor cluster 406) and maintained at fixed voltages (e.g., V_{fly1}, V_{fly2}, and V_{fly3}). Any number of groups at various voltages may be utilized. The weighted voltage capacitor cluster 402, the weighted voltage capacitor cluster 404, and the weighted voltage capacitor cluster 406 desired output voltages at the VFIs (the voltage frequency island 408, the voltage frequency island 410, the voltage frequency island 412, the voltage frequency island 414, the voltage frequency island 416, and the voltage frequency island 418), while reducing charge redistribution loss and voltage scaling time.

More specifically, flying capacitors in the cloud are categorized into different weighted voltage clusters. The weighted voltage capacitor cluster 402 has a V_{fly1} of ⅓ supply voltage (VDD), the weighted voltage capacitor cluster 404 has a V_{fly2} of ¼ VDD, and the weighted voltage capacitor cluster 406 has a V_{fly3} of ½ VDD, respectively. These capacitors are maintained at the voltages of their corresponding WVC clusters. When an SCVR needs to change its output voltage, its flying capacitor controller will select the proper combination of flying capacitors from the clusters. For example, the voltage frequency island 408 may have an output voltage of 7/12 VDD and would be supplied by the weighted voltage capacitor cluster 402 and the weighted voltage capacitor cluster 404 (⅓ VDD and ¼ VDD, respectively). The voltage frequency island 410 may have an output voltage of 13/12 VDD and would be supplied by the weighted voltage capacitor cluster 402, the weighted voltage capacitor cluster 404, and the weighted voltage capacitor cluster 406 (⅓ VDD, ¼ VDD, and ½ VDD, respectively). The voltage frequency island 412 may have an output voltage of ⅓ VDD and would be supplied by the weighted voltage capacitor cluster 402 (⅓ VDD). The voltage frequency island 414 may have an output voltage of ¼ VDD and would be supplied by the weighted voltage capacitor cluster 404 (¼ VDD). The voltage frequency island 416 may have an output voltage of ⅚ VDD and would be supplied by the weighted voltage capacitor cluster 402 and the weighted voltage capacitor cluster 406 (⅓ VDD and ½ VDD, respectively). The voltage frequency island 418 may have an output voltage of ¾ VDD and would be supplied by the weighted voltage capacitor cluster 404 and the weighted voltage capacitor cluster 406 (¼ VDD and ½ VDD, respectively).

Thus, the flying capacitors are charged and discharged around constant voltages. By avoiding charging and discharging the flying capacitors to different voltages, the voltage scaling time is shorter, and redistribution loss is minimized. If, for example, the voltage frequency island 408 switches output voltage from 7/12 VDD to ½ VDD, the flying capacitor controller for the voltage frequency island 408 would select the weighted voltage capacitor cluster 406 instead of the weighted voltage capacitor cluster 402 and the weighted voltage capacitor cluster 404 to supply the correct voltage.

The flying capacitor grouping 400 may utilize the PMS allocation 200 to determine the number of flying capacitors within a WVC cluster to apply to a VFI. For example, the weighted voltage capacitor cluster 402 supplies power to the voltage frequency island 408, the voltage frequency island 410, the voltage frequency island 412, and the voltage frequency island 416. The PMS allocation 200 may be utilized to determine the allocation of the flying capacitors grouped within the weighted voltage capacitor cluster 402 to each of the voltage frequency island 408, the voltage frequency island 410, the voltage frequency island 412, and the voltage frequency island 416.

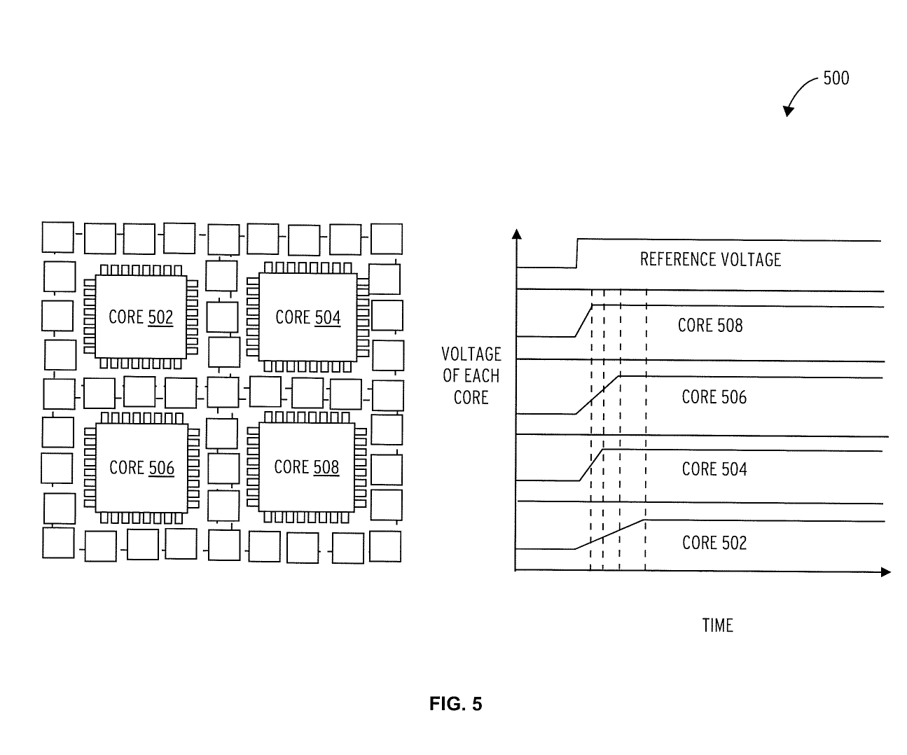

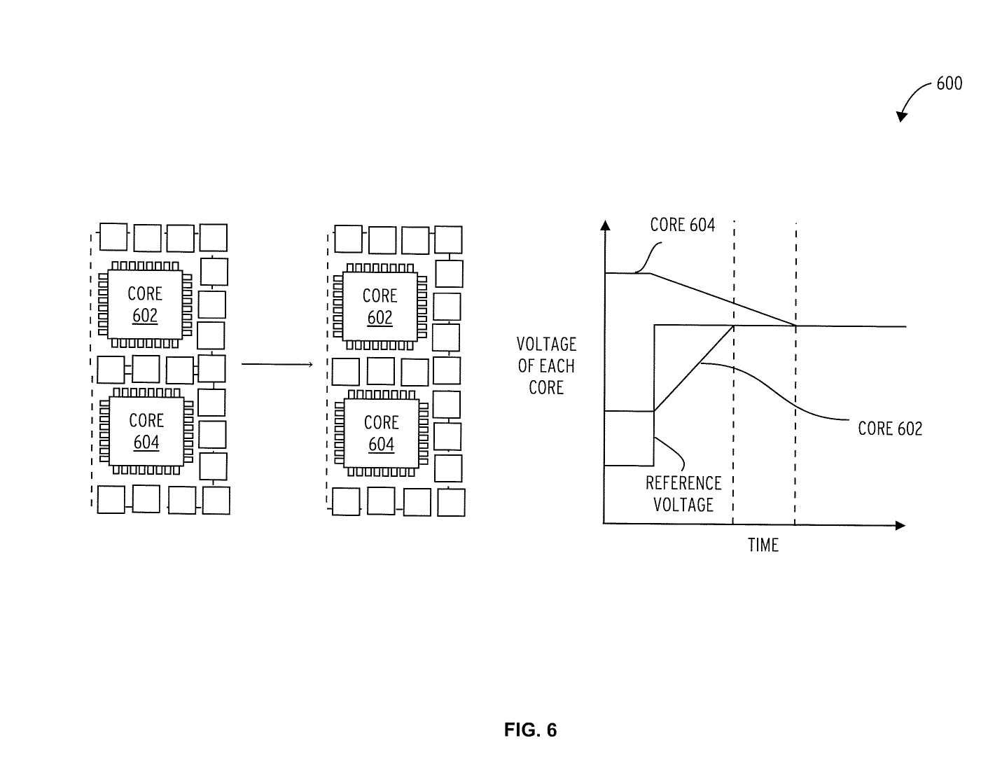

Another problem with existing on-chip PMSs is the inability to synchronize voltage scaling times of cores in the same VFI. FIG. 5 and FIG. 6 illustrate two scenarios causing unsynchronized voltage scaling times among the cores.

Referring to FIG. 5, the voltage scaling 500 comprises a core 502, a core 504, a core 506, and a core 508. Each of the core 502, the core 504, the core 506, and the core 508 may have a different loading condition and may be in the same VFI.

If the SCVR of the core 502, the core 504, the core 506, and the core 508 operate independently without sharing flying capacitors, supply voltages may not scale within the same time because of the differences in load conditions and may cause the flying capacitors of the SCVRs to charge and discharge differently. Unsynchronized voltage scaling times can potentially degrade signal integrity when the cores are communicating with one another.

Referring to FIG. 6, the voltage scaling 600 comprises a core 602 and a core 604. The core 602 and the core 604 begin associated with different VFIs and are reconfigured into the same VFI.

If the SCVR of the core 602 and the core 604 operate independently without sharing flying capacitors, supply voltages may not scale within the same time because of the differences in starting voltage levels and may cause the flying capacitors of the SCVRs to charge and discharge differently. Unsynchronized voltage scaling times can potentially degrade signal integrity when the cores are communicating with one another.

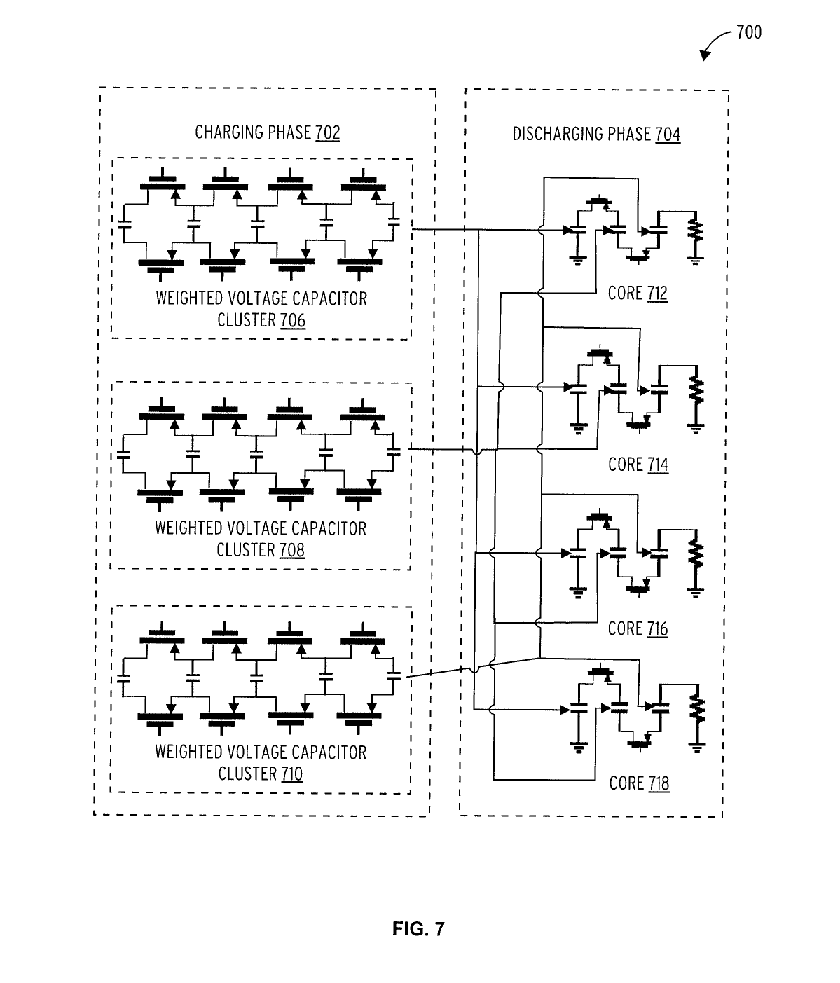

To address this issue, a cloud charging process within the WVC clusters, as illustrated in FIG. 7, is utilized. The flying capacitors have a charging phase and a discharging phase. In the discharging phase, energy from the flying capacitors is transferred to the loading cores. Then, they are returned to the cloud to be charged in parallel with all flying capacitors in the corresponding WVC clusters. Parallel charging in the cloud forces all flying capacitors to behave the same, and thus the SCVRs can scale their output voltages within the same time, regardless of differences in load conditions and/or starting voltage levels.

Referring to FIG. 7, the cloud charging process 700 comprises a charging phase 702, a discharging phase 704, a weighted voltage capacitor cluster 706, a weighted voltage capacitor cluster 708, a weighted voltage capacitor cluster 710, a core 712, a core 714, a core 716, and a core 718.

During the charging phase 702, each of the weighted voltage capacitor cluster 706, the weighted voltage capacitor cluster 708, and the weighted voltage capacitor cluster 710 are charged to their charged voltage, for example V_{fly1}, V_{fly2}, and V_{fly3}, respectively. Each of the weighted voltage capacitor cluster 706, the weighted voltage capacitor cluster 708, and the weighted voltage capacitor cluster 710 may comprise one or more flying capacitors, which are charged to the charged voltage during the charging phase 702. The one or more flying capacitors in each WVC cluster may be charged in parallel with one another. Parallel charging in the cloud allows the one or more flying capacitors to behave in a similar manner, and thus the SCVRs may scale their output voltages within the same time, regardless of differences in load conditions and/or starting voltage levels.

Each of the one or more flying capacitors may be allocated to a core, such as the core 712, the core 714, the core 716, and the 718, based on the voltage and power requirements determined by a flying capacitor controller. During the discharging phase 704, each of the one or more flying capacitors in the weighted voltage capacitor cluster 706, the weighted voltage capacitor cluster 708, and the weighted voltage capacitor cluster 710 discharges energy to the core (e.g., the core 712, the core 714, the core 716, and the core 718) to which it is allocated by the flying capacitor controller.

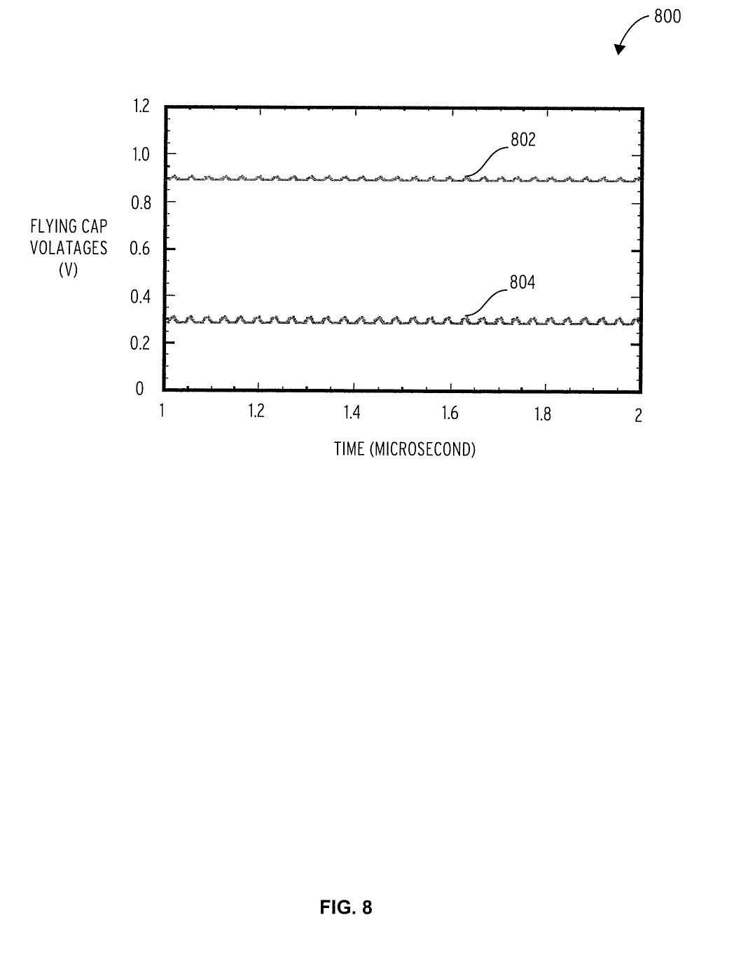

Referring to FIG. 8, the first waveform 800 comprises a weighted voltage capacitor cluster 802 and a weighted voltage capacitor cluster 804.

The first waveform 800 depicts the voltage of the flying capacitors in the weighted voltage capacitor cluster 802 and the weighted voltage capacitor cluster 804 with respect to time. Here, the supply voltage (VDD) is 1.8 V. The weighted voltage capacitor cluster 802 is maintained at ½ VDD (0.9 V), and the weighted voltage capacitor cluster 804 is maintained at ⅙ VDD (0.3 V).

A conventional SCVR is designed to operate with two clock phases. The flying capacitors are charged in the first phase and discharged in the second phase. Multi-phase SCVRs have been implemented [D11-18], but it should be noted that multi-phase in these works refers to multiple SCVR unit cells operating with interleaving phase-shifted clock signals. Each SCVR unit cell, however, operates with two clock phases similarly to a conventional SCVR. Herein, the term “phase” refers to the number of clock phases with which each SCVR unit cell operates. The conventional two-phase operation, though being relatively simple to control, is not flexible enough to efficiently support a cloud capacitor PMS with WVC clusters. For example, to maintain the voltages in the WVC clusters, several two-phase SCVRs with various conversion ratios are needed, each of which requires their own flying capacitors and switches. This extra overhead result in additional delay and loss, which compromise the performance improvement achieved by the disclosed cloud capacitor PMS.

A set of More-than-Two-Phase (MTTP) SCVR topologies is disclosed, which operate with three or more switching phases in one clock cycle, oriented to support the cloud capacitor PMS with WVC clusters. With additional switching phases in a clock cycle, the disclosed MTTP SCVR topologies can provide voltage regulation of the cores and the WVC clusters with significantly lower overhead. FIGS. 8-10 illustrate results for a simple scenario with two WVC clusters and three VFIs.

One embodiment of a three-phase SCVR topology maintains the flying capacitors in two WVC clusters at ⅙ and ½ VDD, while regulating the voltages of cores in three VFIs at ⅔, ½, and ⅓ VDD. In contrast, if conventional two-phase SCVRs are used for the same purpose, an overhead of three times more flying capacitors and two times more switches are required.

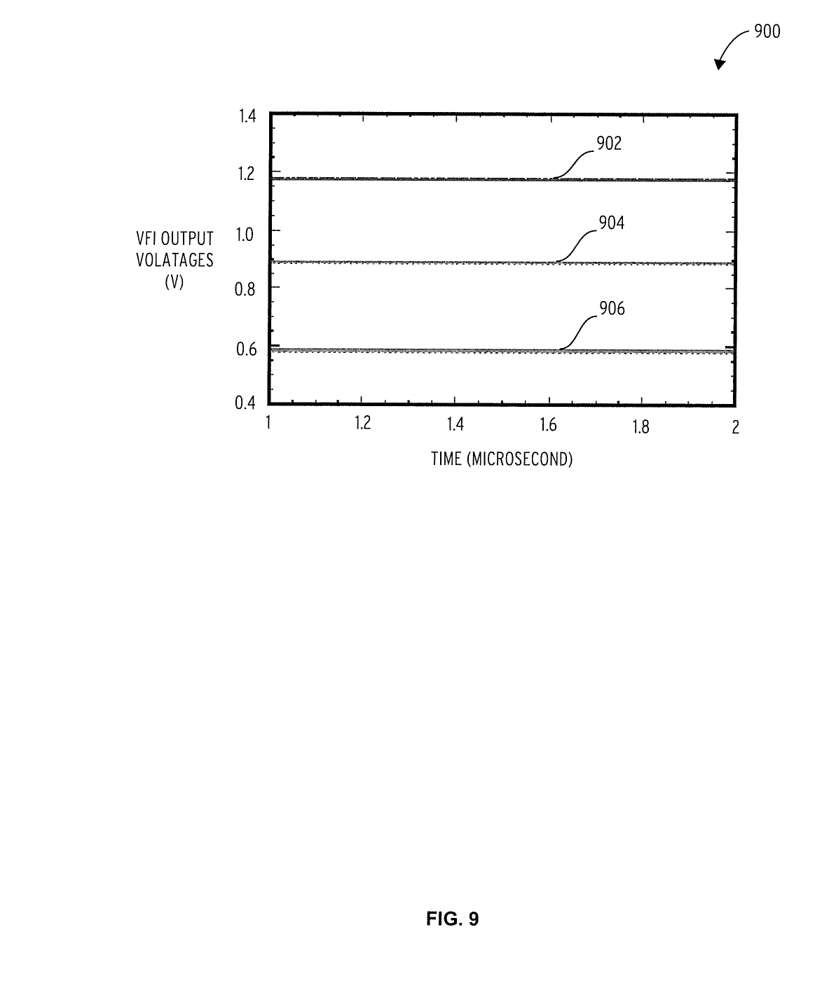

Referring to FIG. 9, the second waveform 900 comprises a voltage frequency island 902, a voltage frequency island 904, and a voltage frequency island 906.

The second waveform 900 depicts the voltage of the voltage frequency island 902, the voltage frequency island 904, and the voltage frequency island 906 with respect to time. Here, the supply voltage (VDD) is 1.8 V. The output voltage is ⅔ VDD (1.2 V), ½ VDD (0.9 V), and ⅓ VDD (0.6 V) for the voltage frequency island 902, the voltage frequency island 904, and the voltage frequency island 906, respectively. The effects of loading may cause the actual output voltages to be lower than the set output voltages. In contrast, if conventional two-phase SCVRs are used for the same purpose, an overhead of three times more flying capacitors and two times more switches are required.

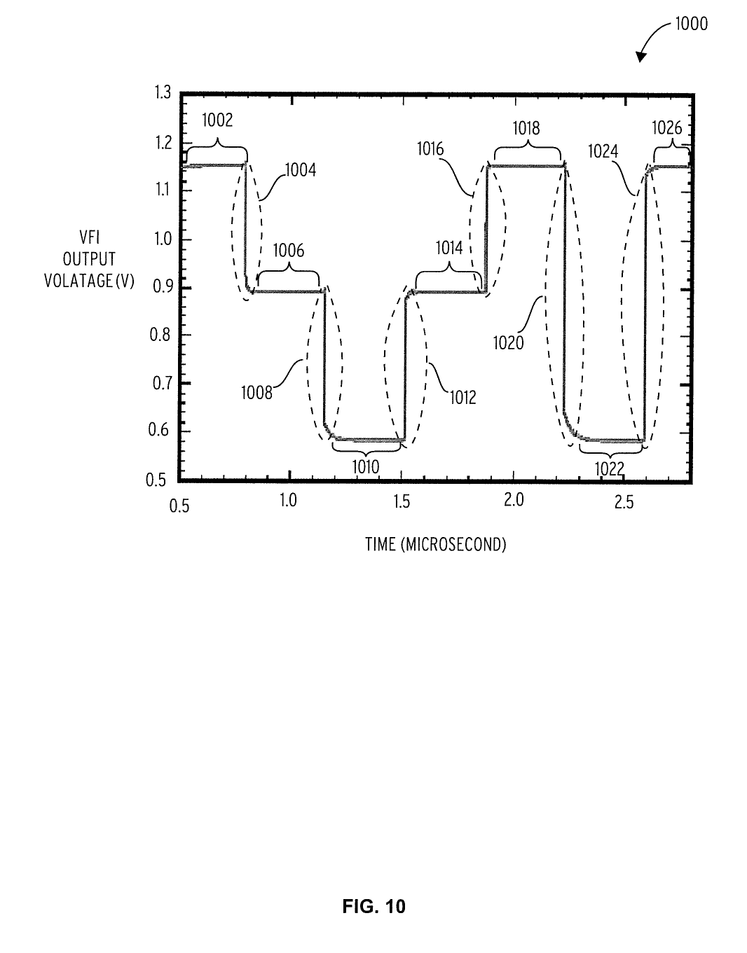

Referring to FIG. 10, the voltage waveform 1000 comprises a first static period 1002, a first transition period 1004, a second static period 1006, a second transition period 1008, a third static period 1010, a third transition period 1012, a fourth static period 1014, a fourth transition period 1016, a fifth static period 1018, a fifth transition period 1020, a sixth static period 1022, a sixth transition period 1024, and a seventh static period 1026.

The voltage waveform 1000 may be for a voltage frequency island with a SCVR to alter the voltage during static periods to a fix value, such as ⅔ VDD, ½ VDD, and ⅓ VDD, where VDD is 1.8 V. During the first static period 1002, the output voltage is ⅔ VDD. During the first transition period 1004, the SCVR alters the output voltage from ⅔ VDD to ½ VDD. During the second static period 1006, the output voltage is ½ VDD. During the second transition period 1008, the SCVR alters the output voltage from ½ VDD to ⅓ VDD. During the third static period 1010, the output voltage is ⅓ VDD. During the third transition period 1012, the SCVR alters the output voltage from ⅓ VDD to ½ VDD. During the fourth static period 1014, the output voltage is ½ VDD. During the fourth transition period 1016, the SCVR alters the output voltage from ½ VDD to ⅔ VDD. During the fifth static period 1018, the output voltage is ⅔ VDD. During the fifth transition period 1020, the SCVR alters the output voltage from ⅔ VDD to ⅓ VDD. During the sixth static period 1022, the output voltage is ⅓ VDD. During the sixth transition period 1024, the SCVR alters the output voltage from ⅓ VDD to ⅔ VDD. During the seventh static period 1026, the output voltage is ⅔ VDD. The SCVR may alter the voltage by changing the WVC clusters supplying the VFI. By utilizing a WVC-Cluster technique, the output voltage may scale up and down quickly (e.g., <2 nanoseconds) with a minimized charge redistribution loss.

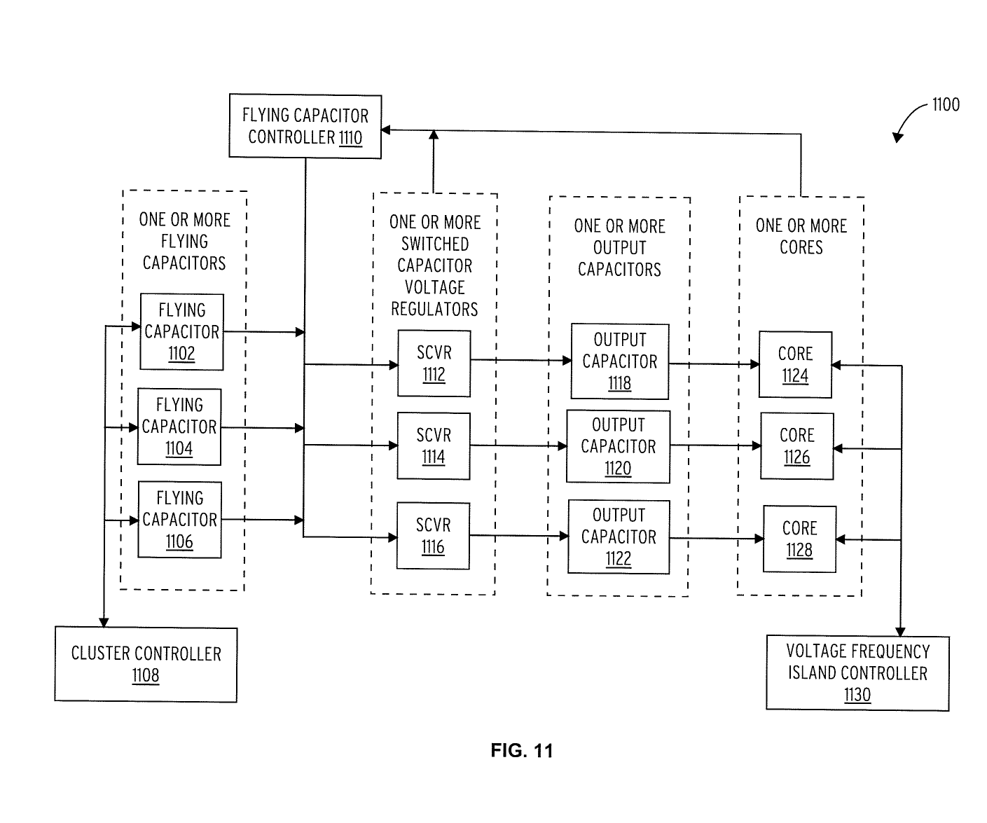

Referring to FIG. 11, the on-chip power management system 1100 comprises a flying capacitor 1102, a flying capacitor 1104, a flying capacitor 1106, a cluster controller 1108, a flying capacitor controller 1110, a SCVR 1112, a SCVR 1114, a SCVR 1116, an output capacitor 1118, an output capacitor 1120, an output capacitor 1122, a core 1124, a core 1126, a core 1128, and a voltage frequency island controller 1130.

The flying capacitor 1102, the flying capacitor 1104, and the flying capacitor 116 may store energy that may be discharged to power the core 1124, the core 1126, and the core 1128 (via an SCVR and output capacitor). The flying capacitor 1102, the flying capacitor 1104, and the flying capacitor 1106 may be set to a specific supply voltage. The cluster controller 1108 may group one or more of the flying capacitor 1102, the flying capacitor 1104, and the flying capacitor 1106 into a weighted voltage capacitor cluster. Flying capacitors grouped into a weighted voltage capacitor clusters by the cluster controller 1108 are maintained at the same voltage. Each of the weighted voltage capacitor clusters may be charged at the same time, as well as, being discharged to the SCVRs at the same time.

The flying capacitor controller 1110 may allocate the flying capacitor 1102, the flying capacitor 1104, and the flying capacitor 1106 to the SCVR 1112, the SCVR 1114, and the SCVR 1116. The flying capacitor controller 1110 may receive a control signal from the cores (i.e., core 1124, the core 1126, and the core 1128) and the SCVRs (i.e., the SCVR 1112, the SCVR 1114, and the SCVR 1116). The control signals may comprise power demand and voltage. The flying capacitor controller 1110 allocates the flying capacitor 1102, the flying capacitor 1104, and the flying capacitor 1106 based on the control signals, and as discussed in FIG. 2 and FIG. 4.

The SCVR 1112, the SCVR 1114, and the SCVR 1116 receive the stored energy from the flying capacitor 1102, the flying capacitor 1104, and the flying capacitor 1106, if allocated by the flying capacitor controller 1110. The SCVR 1112, the SCVR 1114, and the SCVR 1116 combine the discharged stored energy and send the combined discharged energy to the output capacitor 1118, the output capacitor 1120, and the output capacitor 1122, respectively. The SCVR 1112, the SCVR 1114, and the SCVR 1116 alter the voltage from the supply voltage(s) to the output voltage. The SCVR 1112, the SCVR 1114, and the SCVR 1116 may send a control signal to the flying capacitor controller 1110 to allocate the flying capacitor 1102, the flying capacitor 1104, and the flying capacitor 1106 based on voltage. The SCVR 1112, the SCVR 1114, and the SCVR 1116 may comprises a more than two phase topology and may operate with three or more switching phases in a clock cycle.

The output capacitor 1118, the output capacitor 1120, and the output capacitor 1122 store the energy received from the SCVR 1112, the SCVR 1114, and the SCVR 1116, respectively, and discharged the energy to the core 1124, the core 1126, and the core 1128, respectively.

The core 1124, the core 1126, and the core 1128 received the stored energy from the output capacitor 1118, the output capacitor 1120, and the output capacitor 1122, respectively. The core 1124, the core 1126, and the core 1128 may send a control signal to the flying capacitor controller 1110. The control signal may comprise the power demand of each of the core 1124, the core 1126, and the core 1128. The core 1124, the core 1126, and the core 1128 may be grouped together based on power demands into a voltage frequency island by the voltage frequency island controller 1130.

Massive multi-core systems with dynamic VFIs require more complicated MTTP SCVRs, which require proper design to maximize the performance of the cloud capacitor PMS. A model characterizing the MTTP SCVR topologies may be utilized to optimize performance for MTTP SCVRs in various implementations. The MTTP SCVRs may be modeled by the well-known (transformer+output impedance) equivalent circuit [D20]. The output impedance is also expected to have SSL (slow-switching-limit) and FSL (fast-switching-limit) characteristics [D20]. Additionally, a model for the output impedance of any MTTP SCVR topology may be utilized. A general model for the performance limit of two-phase SCVR is disclosed in [D21]. A similar model may be used for the performance limit of the disclosed MTTP SCVRs.

For testing and validation, resistors may be used to represent cores for MTTP SCVRs supporting small groups of VFIs and WVC clusters, and to then characterize the efficiency of MTTP SCVRs and the voltage scaling performance of the WVC clusters. Next, the size of VFIs and WVC clusters may be scaled and the cloud capacitor DCA may be applied. The cloud capacitor PMS may be tested with multiple digital cores having simplified functions and low to moderate power consumption. Because the SCVRs-based PMSs are easily scalable, it is not necessary to model and test ultra-high power massive-multi-core systems.

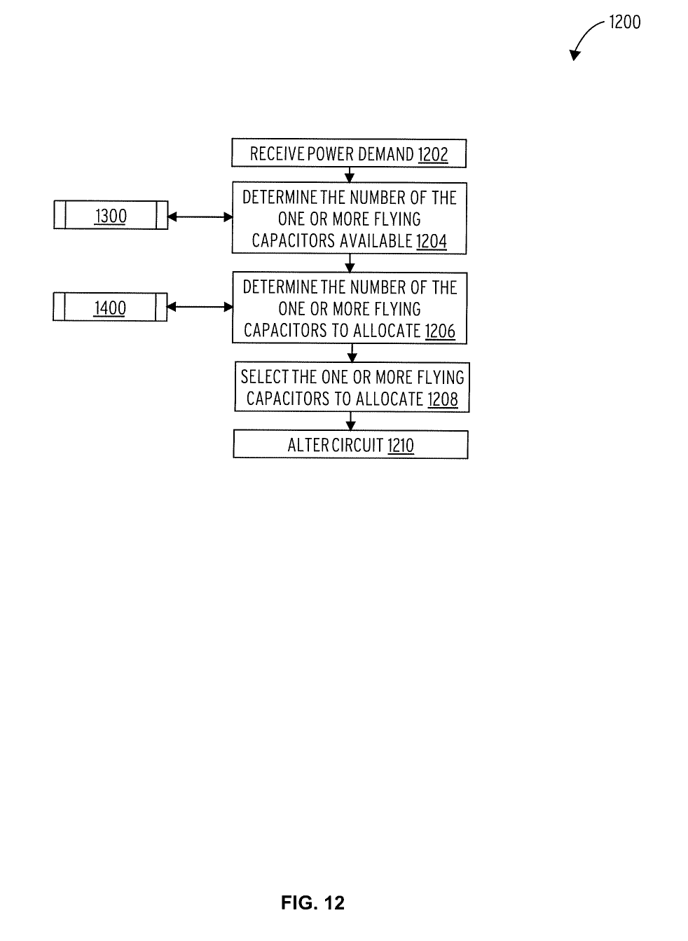

Referring to FIG. 12, the flying capacitor allocation method 1200 receives a power demand for each of one or more cores associated with one or more switched capacitor voltage regulators (block 1202). The number of the one or more flying capacitors available to allocate to the one or more switched capacitor voltage regulators is determined (block 1204). The number available may be further determined utilizing subroutine block 1300. The number of the one or more flying capacitors to allocate to each of the one or more switched capacitor voltage regulators are then determined (block 1206). The number to allocate may be further determined utilizing subroutine block 1400. The one or more flying capacitors to allocate to each of the one or more switched capacitor voltage regulators are selected (block 1208). A circuit is altered to couple the one or more switched capacitor voltage regulators to the one or more flying capacitors based of the one or more flying capacitors selected to be allocated to each of the one or more switched capacitor voltage regulators (block 1210).

The flying capacitor allocation method 1200 may perform an additional step(s) to determine one or more factors prior to determining the number of the one or more flying capacitors to allocate to each of the one or more switched capacitor voltage regulators. The factors may include the efficiency of the topology of each of the one or more switched capacitor voltage regulators, the number of the one or more cores, the power characteristics of the one or more cores, the output voltage of each of the one or more switched capacitor voltage regulators, and the complexity of an interconnection. The interconnection may be between the flying capacitors and the switched capacitor voltage regulator, the switched capacitor voltage regulator and the one or more output capacitors, and the one or more output capacitors and the one or more cores.

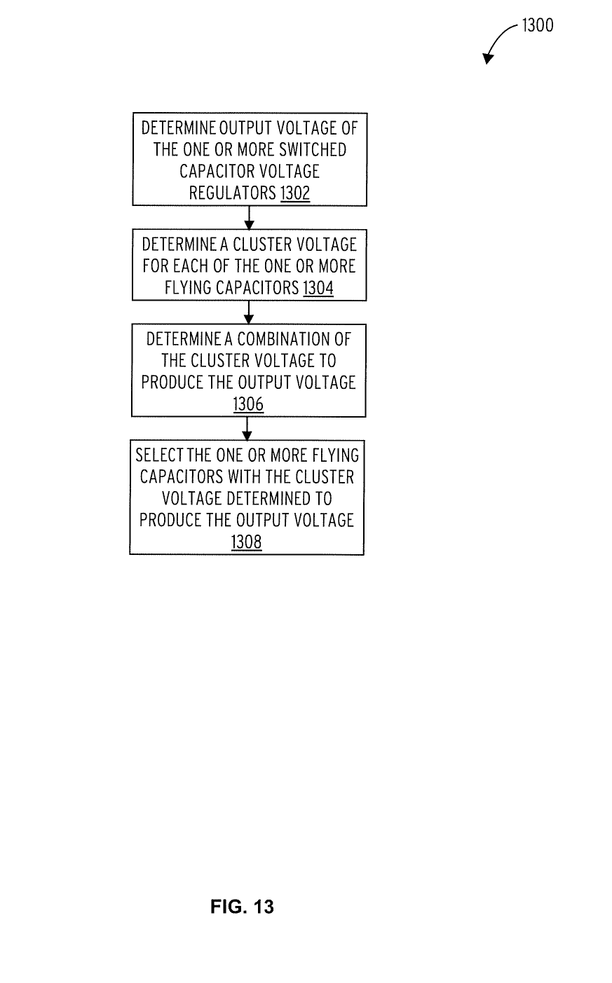

Referring to FIG. 13, the subroutine block 1300 determines an output voltage of the one or more switched capacitor voltage regulators (block 1302). A cluster voltage is determined for each of the one or more flying capacitors (block 1304). A combination of the cluster voltages to produce the output voltage is determined (block 1306). The one or more flying capacitors with the cluster voltage determined to produce the output voltage are then selected to be the one or more flying capacitors available (block 1308).

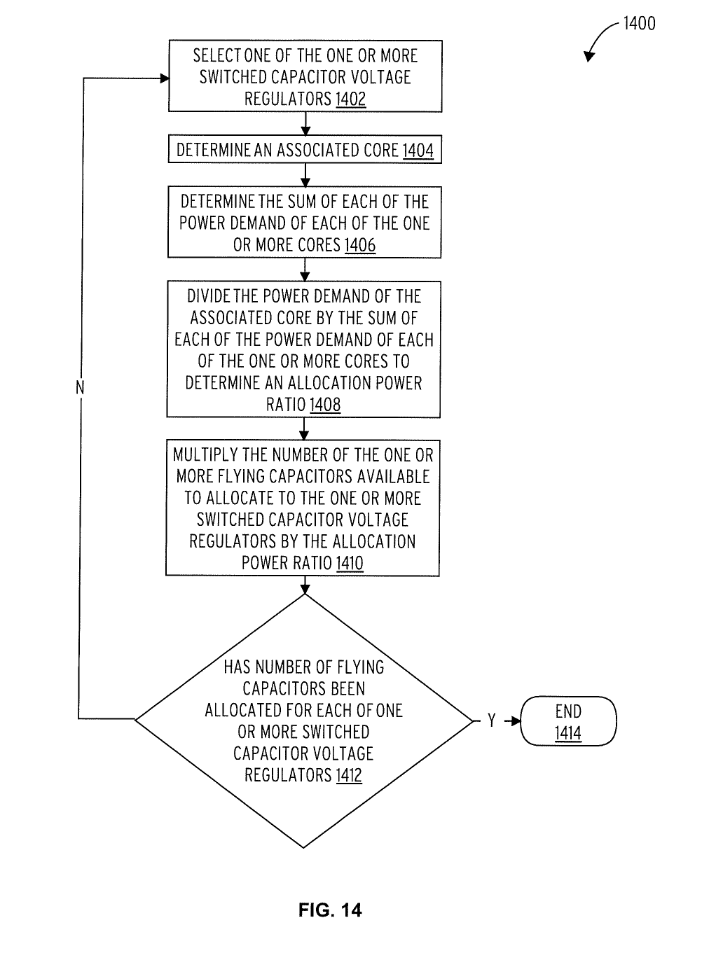

Referring to FIG. 14, the subroutine block 1400 selects one of the one or more switched capacitor voltage regulators (block 1402). An associated core is determined based on the selected switched capacitor voltage regulator (block 1404). The sum of each of the power demand of each of the one or more cores is determined (block 1406). The power demand may be a percentage of the maximum power. The power demand of the associated core is divided by the sum of each of the power demand of each of the one or more cores to determine an allocation power ratio (block 1408). The number of the one or more flying capacitors available to allocate to the one or more switched capacitor voltage regulators is multiplied by the allocation power ratio (block 1410). The subroutine block 1400 determines whether a number of flying capacitors has been allocated for each of one or more switched capacitor voltage regulators (decision block 1412). If so, the subroutine block 1400 ends (done block 1414). If not, another one of the one or more switched capacitor voltage regulators is selected.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually or collectively, by a wide range of hardware, software, firmware, or any combination thereof can be viewed as being composed of various types of circuitry.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

What is claimed is:

1. An on-chip power management system comprising:
one or more cores;
one or more switched capacitor voltage regulators, each of the one or more switched capacitor voltage regulators supplying power at an output voltage to one of the one or more cores;
one or more flying capacitors, the one or more flying capacitors supplying the power at a supply voltage to each of the one or more switched capacitor voltage regulators; and
a flying capacitor controller, the flying capacitor controller allocating each of the one or more flying capacitors to the one or more switched capacitor voltage regulators.

2. The on-chip power management system of claim 1, wherein the flying capacitor controller allocates each of the one or more flying capacitors based on the power demanded by the each of the one or more cores.

3. The on-chip power management system of claim 2, wherein the flying capacitor controller allocates each of the one or more flying capacitors based on a normalized power ratio of each of the one or more cores and the number of the one or more flying capacitors.

4. The on-chip power management system of claim 1 further comprising one or more output capacitors, the one or more output capacitors receiving the output voltage from the one or more switched capacitor voltage regulators and sending the output voltage to the one or more cores.

5. The on-chip power management system of claim 4, wherein the one or more output capacitors are grouped into one or more groups of the one or more output capacitors, each of the one or more groups of the one or more output capacitors distributed around one of the one or more cores.

6. The on-chip power management system of claim 1 further comprising a voltage frequency island controller, the voltage frequency island controller grouping the one or more cores into one or more voltage frequency islands.

7. The on-chip power management system of claim 6, wherein the voltage frequency island controller groups the one or more cores into the one or more voltage frequency islands based on the power demanded by the one or more cores.

8. The on-chip power management system of claim 1 further comprising a cluster controller, the cluster controller grouping the one or more flying capacitors into one or more weighted voltage capacitor clusters based on the supply voltage, each of the one or more weighted voltage capacitor clusters having a different supply voltage.

9. The on-chip power management system of claim 8, wherein each of the one or more weighted voltage capacitor clusters are charged at the same time.

10. The on-chip power management system of claim 8, wherein each of the one or more weighted voltage capacitor clusters are discharged at the same time.

11. The on-chip power management system of claim 1, wherein the one or more switched capacitor voltage regulators comprises a more than two phase topology.

12. The on-chip power management system of claim 11, wherein the one or more switched capacitor voltage regulators operate with three or more switching phases in a clock cycle.

13. A method to allocate one or more flying capacitors to one or more switched capacitor voltage regulators comprising:
receiving a power demand for each of one or more cores associated with the one or more switched capacitor voltage regulators;
determining the number of the one or more flying capacitors available to allocate to the one or more switched capacitor voltage regulators;
determining the number of the one or more flying capacitors to allocate to each of the one or more switched capacitor voltage regulators;
selecting the one or more flying capacitors to allocate to each of the one or more switched capacitor voltage regulators; and
altering a circuit to couple the one or more switched capacitor voltage regulators to the one or more flying capacitors based on the one or more flying capacitors selected to be allocated to each of the one or more switched capacitor voltage regulators.

14. The method of claim 13, wherein determining the number of the one or more flying capacitors available to allocate to the one or more switched capacitor voltage regulators comprises:
determining an output voltage of the one or more switched capacitor voltage regulators;
determining a cluster voltage for each of the one or more flying capacitors;
determining a combination of the cluster voltage to produce the output voltage; and
selecting the one or more flying capacitors with the cluster voltage determined to produce the output voltage to be the one or more flying capacitors available.

15. The method of claim 13, wherein determining the number of the one or more flying capacitors to allocate to each of the one or more switched capacitor voltage regulators comprises:
selecting one of the one or more switched capacitor voltage regulators;
determining an associated core to the one of the one or more switched capacitor voltage regulators selected;
determining the sum of each of the power demand of each of the one or more cores;
dividing the power demand of the associated core by the sum of each of the power demand of each of the one or more cores to determine an allocation power ratio; and
multiplying the number of the one or more flying capacitors available to allocate to the one or more switched capacitor voltage regulators by the allocation power ratio.

16. The method of claim 15, wherein the power demand is a percentage of the maximum power.

17. The method of claim 13, further comprising:
determining an efficiency of a topology of each of the one or more switched capacitor voltage regulators; and
wherein determining the number of the one or more flying capacitors to allocate to each of the one or more switched capacitor voltage regulators depends on the efficiency of the topology of each of the one or more switched capacitor voltage regulators.

18. The method of claim 13, further comprising:
determining a number of the one or more cores; and
wherein determining the number of the one or more flying capacitors to allocate to each of the one or more switched capacitor voltage regulators depends on the number of the one or more cores.

19. The method of claim 13, further comprising:
determining power characteristics of the one or more cores; and
wherein determining the number of the one or more flying capacitors to allocate to each of the one or more switched capacitor voltage regulators depends on the power characteristics of the one or more cores.

20. The method of claim 13, further comprises:
determining an output voltage of each of the one or more switched capacitor voltage regulators; and
wherein determining the number of the one or more flying capacitors to allocate to each of the one or more switched capacitor voltage regulators depends on the output voltage of each of the one or more switched capacitor voltage regulators.

21. The method of claim 13, further comprising:
determining a complexity of an interconnection; and
wherein determining the number of the one or more flying capacitors to allocate to each of the one or more switched capacitor voltage regulators depends on the complexity of the interconnection.

22. A non-transitory computer-readable storage medium, the computer-readable storage medium including instructions that when executed by a computer, cause the computer to:
receive a power demand for each of one or more cores associated with one or more switched capacitor voltage regulators;
determine the number of one or more flying capacitors available to allocate to the one or more switched capacitor voltage regulators;
determine the number of the one or more flying capacitors to allocate to each of the one or more switched capacitor voltage regulators;
select the one or more flying capacitors to allocate to each of the one or more switched capacitor voltage regulators; and
alter a circuit to couple the one or more switched capacitor voltage regulators to the one or more flying capacitors based on the one or more flying capacitors selected to be allocated to each of the one or more switched capacitor voltage regulators.

23. The computer-readable storage medium of claim 22, wherein determining the number of the one or more flying capacitors available to allocate to the one or more switched capacitor voltage regulators comprises:
determine an output voltage of the one or more switched capacitor voltage regulators;
determine a cluster voltage for each of the one or more flying capacitors;
determine a combination of the cluster voltage to produce the output voltage; and
select the one or more flying capacitors with the cluster voltage determined to produce the output voltage to be the one or more flying capacitors available.

24. The computer-readable storage medium of claim 22, wherein determining the number of the one or more flying capacitors to allocate to each of the one or more switched capacitor voltage regulators comprises:
select one of the one or more switched capacitor voltage regulators;
determine an associated core to the one of the one or more switched capacitor voltage regulators selected;
determine the sum of each of the power demand of each of the one or more cores;
divide the power demand of the associated core by the sum of each of the power demand of each of the one or more cores to determine an allocation power ratio; and
multiply the number of the one or more flying capacitors available to allocate to the one or more switched capacitor voltage regulators by the allocation power ratio.

25. The computer-readable storage medium of claim 24, wherein the power demand is a percentage of the maximum power.

26. The computer-readable storage medium of claim 22, wherein the instructions further configure the computer to:
determine an efficiency of a topology of each of the one or more switched capacitor voltage regulators; and
wherein determining the number of the one or more flying capacitors to allocate to each of the one or more switched capacitor voltage regulators depends on the efficiency of the topology of each of the one or more switched capacitor voltage regulators.

27. The computer-readable storage medium of claim 22, wherein the instructions further configure the computer to:
determine a number of the one or more cores; and
wherein determining the number of the one or more flying capacitors to allocate to each of the one or more switched capacitor voltage regulators depends on the number of the one or more cores.

28. The computer-readable storage medium of claim 22, wherein the instructions further configure the computer to:
determine power characteristics of the one or more cores; and
wherein determining the number of the one or more flying capacitors to allocate to each of the one or more switched capacitor voltage regulators depends on the power characteristics of the one or more cores.

29. The computer-readable storage medium of claim 22, further comprises:
determine an output voltage of each of the one or more switched capacitor voltage regulators; and
wherein determining the number of the one or more flying capacitors to allocate to each of the one or more switched capacitor voltage regulators depends on the output voltage of each of the one or more switched capacitor voltage regulators.

30. The computer-readable storage medium of claim 22, wherein the instructions further configure the computer to:
determine a complexity of an interconnection; and
wherein determining the number of the one or more flying capacitors to allocate to each of the one or more switched capacitor voltage regulators depends on the complexity of the interconnection.

31. A computing apparatus, the computing apparatus comprising:
a processor; and
a memory storing instructions that, when executed by the processor, configure the apparatus to:
receive a power demand for each of one or more cores associated with one or more switched capacitor voltage regulators;
determine the number of one or more flying capacitors available to allocate to the one or more switched capacitor voltage regulators;
determine the number of the one or more flying capacitors to allocate to each of the one or more switched capacitor voltage regulators;
select the one or more flying capacitors to allocate to each of the one or more switched capacitor voltage regulators; and
alter a circuit to couple the one or more switched capacitor voltage regulators to the one or more flying capacitors based on the one or more flying capacitors selected to be allocated to each of the one or more switched capacitor voltage regulators.

32. The computing apparatus of claim 31, wherein determining the number of the one or more flying capacitors available to allocate to the one or more switched capacitor voltage regulators comprises:
determine an output voltage of the one or more switched capacitor voltage regulators;
determine a cluster voltage for each of the one or more flying capacitors;
determine a combination of the cluster voltage to produce the output voltage; and
select the one or more flying capacitors with the cluster voltage determined to produce the output voltage to be the one or more flying capacitors available.

33. The computing apparatus of claim 31, wherein determining the number of the one or more flying capacitors to allocate to each of the one or more switched capacitor voltage regulators comprises:
select one of the one or more switched capacitor voltage regulators;
determine an associated core to the one of the one or more switched capacitor voltage regulators selected;
determine the sum of each of the power demand of each of the one or more cores;
divide the power demand of the associated core by the sum of each of the power demand of each of the one or more cores to determine an allocation power ratio; and
multiply the number of the one or more flying capacitors available to allocate to the one or more switched capacitor voltage regulators by the allocation power ratio.

34. The computing apparatus of claim 33, wherein the power demand is a percentage of the maximum power.

35. The computing apparatus of claim 31, wherein the instructions further configure the apparatus to:
determine an efficiency of a topology of each of the one or more switched capacitor voltage regulators; and
wherein determining the number of the one or more flying capacitors to allocate to each of the one or more switched capacitor voltage regulators depends on the efficiency of the topology of each of the one or more switched capacitor voltage regulators.

36. The computing apparatus of claim 31, wherein the instructions further configure the apparatus to:
determine a number of the one or more cores; and
wherein determining the number of the one or more flying capacitors to allocate to each of the one or more switched capacitor voltage regulators depends on the number of the one or more cores.

37. The computing apparatus of claim 31, wherein the instructions further configure the apparatus to:
determine power characteristics of the one or more cores; and
wherein determining the number of the one or more flying capacitors to allocate to each of the one or more switched capacitor voltage regulators depends on the power characteristics of the one or more cores.

38. The computing apparatus of claim 31, further comprises:
determine an output voltage of each of the one or more switched capacitor voltage regulators; and
wherein determining the number of the one or more flying capacitors to allocate to each of the one or more switched capacitor voltage regulators depends on the output voltage of each of the one or more switched capacitor voltage regulators.

39. The computing apparatus of claim 31, wherein the instructions further configure the apparatus to:
determine a complexity of an interconnection; and
wherein determining the number of the one or more flying capacitors to allocate to each of the one or more switched capacitor voltage regulators depends on the complexity of the interconnection.
